(19) United States
(12) Patent Application Publication
(10) Pub. No.: US 2010/0160483 A1
(43) Pub. Date: Jun. 24, 2010

(54) POLYMETHYLMETHACRYLATE BONE CEMENT COMPOSITION FOR CONTROLLED HYPERTHERMIA TREATMENT

(75) Inventors: Sebastian VOGT, Erfurt (DE); Hubert Büchner, Reinheim (DE)

Correspondence Address: Briscoe, Kurt G.;Norris McLaughlin & Marcus, PA, 875 Third Avenue, 8th Floor, New York, NY, 10022, US

(73) Assignee: HERAEUS MEDICAL GMBH, Wehrheim (DE)

(21) Appl. No.: 12/641,895

(22) Filed: Dec. 18, 2009

(30) Foreign Application Priority Data
Dec. 22, 2008 (DE) 10 2008 064 036.0

(51) Int. Cl. C08L 33/12

(52) U.S. Cl. 523/117

(57) ABSTRACT

The invention relates to a polymethylmethacrylate bone cement composition that contains polymethylmethacrylate, radio-opaquer, methylmethacrylate and/or alkylmethacrylates, and an initiator system and comprises, in addition, ferromagnetic and/or superparamagnetic particles of a particle size of up to maximally 500 μm—which allows it to be heated by alternating magnetic fields—and further contains at least one biodegradable or biocompatible crystalline substance having a melting point in the range of 43-46° C. The cured cement can be used for local over-heating (hyperthermia) therapy in the absence of undesired temperature peaks.

The subject matter of the invention is a polymethylmethacrylate bone cement that can be heated by alternating magnetic fields and is used for controlled hyperthermia treatment of bone metastases.

Cancerous diseases of the prostate, cervix, and breast are often associated with the formation of metastases in the skeletal system. Bone metastases are a very serious problem, especially in the advanced, final stage of the cancerous disease. In some cases, bone metastases are associated with extreme pain for the patient. Moreover, metastases in the spinal column lead to compression fractures due to destruction of the bone substance of the vertebra. Upon collapse of the vertebrae, the vertebral canal, and thus the spinal cord, becomes compressed leading, as a corollary, to symptoms of paralysis and extreme pain. Therefore, an attempt is often made to re-fill the destroyed vertebrae with bone cement as a palliative measure in the final months of the life of the patients in order to reduce or prevent compression of the spinal cord. This measure often allows an improvement of the quality of life of the patients to be achieved. The bone cement that is used for re-filling therefore needs to possess only low mechanical strength.

There have been attempts in the past to dope the bone cement that is used to re-fill the destroyed vertebrae with cytostatic agents in order to reduce or delay further growth of the metastases by local release of the cytostatic agents (DE 35 13 938). However, the high toxicity of the cytostatic agents, in particular of methotrexate, is a problem in this context. If the dosage is too high, undesired side effects may easily occur. Accordingly, the dosing of cytostatic agents in the cement is very problematic.

Hyperthermia as part of solid tumor therapy attracted increased interest in recent years. Aside from whole body hyperthermia, still a subject of contentious debate, especially local hyperthermia has been investigated more closely as a therapeutic method. It involves heating tumor tissue to temperatures in the range of 40-46° C. Local over-heating of the tumor tissue is intended to induce necrosis of the tumor or increase the sensitivity of the tumor tissue to cytostatic agents or radiation therapy due to thermal pre-damaging of the tumor cells. Aside from conventional methods of local heating using microwaves, ultrasound, and magnetic “thermoseeds”, especially developments aimed at utilizing magnetic/superparamagnetic particles, in particular nano-particles, have been made. These particles heat up when exposed to alternating magnetic fields. The printed patent specifications, EP 1 952 825, CN101219071, WO2008074804, US 2006/147381, EP 1 883 425, WO2007142674, US 2005/249817, and U.S. Pat. No. 6,541,039, are exemplary for these developments. Of particular interest in this context is US 2005/249817, in which magnetic nano-particles having a Curie temperature of 40-46° C. are proposed for the hyperthermia treatment. Above the Curie temperature, the proposed particles show only paramagnetic behavior which limits the input of energy into the tumor tissue. This is designed to attain a temperature regulation in order to prevent unnecessary over-heating of the tissue beyond 46° C. Temperatures of approx. 43° C. are to be considered sufficient for damaging the tumor tissue and/or inducing necrosis therein. Heating to higher temperatures provides no additional advantage and is associated with the risk of effecting thermal damage to the surrounding healthy tissue.

On principle, common polymethylmethacrylate bone cements can be used to re-fill bone cavities that were produced by bone metastases. Thus far, polymethylmethacrylate bone cements share a common basic structure. Polymethylmethacrylate bone cements have been known and are clinically proven for many years. They are based on the groundbreaking work of Sir Charnley (Charnley, J.: Anchorage of the femoral head prosthesis of the shaft of the femur. J. Bone Joint Surg. 42 (1960) 28-30.). The basic structure of the polymethylmethacrylate bone cements has basically remained unchanged ever since. Polymethylmethacrylate bone cements consist of a liquid monomer component and a powder component. The monomer component generally contains the monomer, methylmethacrylate, and an activator (N,N-dimethyl-p-toluidine) dissolved therein. The powder component consists of one or more polymers that are made by polymerization, preferably suspension polymerization, based on methylmethacrylate and co-monomers, such as styrene, methylacrylate or similar monomers, a radio-opaquer, and the initiator, dibenzoylperoxide. When mixing the powder component with the monomer component, swelling of the polymers of the powder component in the methylmethacrylate leads to the formation of a dough that can be shaped plastically. Simultaneously, the activator, N,N-dimethyl-p-toluidine, reacts with dibenzoylperoxide which decomposes while forming radicals. The radicals thus formed initiate the radical polymerization of the methylmethacrylate. Upon advancing polymerization of the methylmethacrylate, the viscosity of the cement dough increases until the cement dough solidifies and is thus cured.

Monomer mixtures for bone cements that can be heated by alternating magnetic fields have been proposed, for example, in European patent application 08 017 156.4. The heating activates initiators that disintegrate thermally, and allows the material to become cured.

The invention is based on the object to develop a polymethylmethacrylate bone cement that allows bone cavities caused by bone metastases to be re-filled. The polymethylmethacrylate bone cement is designed to be heated by exposure to alternating magnetic fields to the degree that a targeted, local thermal damaging effect on re-growing tumor tissue becomes possible. However, undesirable temporary temperature peaks are to be safely prevented in this context in order to limit the risk of causing thermal damage to the surrounding healthy tissue, which might lead to pain and further undesirable consequences for the patient.

The object is met by providing a polymethylmethacrylate bone cement for controlled hyperthermia treatment with the common components, polymethylmethacrylate, radio-opaquer, methylmethacrylate and/or alkylmethacrylates as well as initiator system, that contains ferromagnetic and/or superparamagnetic particles of a particle size of maximally 500 μm and at least one biodegradable or biocompatible crystalline substance having a melting point in the range of 42-80° C. The invention therefore relates to polymethylmethacrylate bone cement compositions for controlled hyperthermia treatment, containing
A polymethylmethacrylate;
B radio-opaquer;
C methylmethacrylate and/or alkylmethacrylates;
D initiator system;
E ferromagnetic and/or superparamagnetic particles of a particle size of up to maximally 500 μm; as well as
F at least one biodegradable or biocompatible crystalline substance having a melting point in the range of 42-80° C.

Exposing the ferromagnetic and/or superparamagnetic particles contained in the cement to alternating magnetic fields allows the cured polymethylmethacrylate bone cement to be heated in vivo. The biodegradable or biocompatible crystalline substance having a melting point in the range of 42-80° C. that is contained in the cement is also heated in the process. The temperature of the cement increases proportional to the input of energy until the melting point of the crystalline substance is reached. Then, the temperature of the cement remains at the melting temperature until all of the crystalline substance has melted. The energy added is stored in the form of latent energy. Temperature peaks are thus safely prevented and undesired over-heating of the tissue and adjacent body regions is prevented.

Preferably, the ferromagnetic particles are partially or completely enveloped by the crystalline substance. Iron, cobalt, samarium-cobalt, neodymium-iron (Nd₂Fe₁₄) are preferred as ferromagnetic particles. Magnetite preferably serves as superparamagnetic particles.

1,2,3-Trilauroyl glycerol, 1,2,3-trimyristyl glycerol, 1,2,3-tripalmitoyl glycerol, lauric acid, myristic acid, and palmitic acid are considered as biodegradable crystalline substances. 1,2,3-Trilauroyl glycerol having a melting temperature of 43° C. is particularly preferred. The fraction of the biodegradable substance that is present in the polymethylmethacrylate bone cement usefully is up to 30 weight percent. This ensures safe prevention of temperature peaks.

In addition, the bone cement composition according to the invention can contain cytostatic agents. Suitable cytostatic agents for the respective indication are known to the person skilled in the art. The cytostatic agent, methotrexate, is a preferred standard in this context.

Compositions according to the invention are well-suited for the production of means for temporary over-heating of body regions (hyperthermia) with undesired temperature peaks, in particular in the area of the spinal column, preferably to 43-46° C.

In particular, the compositions according to the invention are designated for palliative re-filling and stabilization of bone cavities formed by bone metastases, whereby the cement is designed to facilitate a targeted local hyperthermia treatment in order to be able to subject possibly regrowing tumor tissue to local palliative treatment. By this means, it is intended that the polymethylmethacrylate bone cement improves the quality of life of tumor patients.

The invention is illustrated by the examples presented in the following without limiting the scope of the invention. Like in other parts of the description, any specification of parts and percentages refers to the weight unless specified otherwise.

### EXAMPLE 1

### Production of Cement Powder

A Turbula mixer and porcelain grinding media were used to intensively triturate 30.0 g 1,2,3-trilauroyl glycerol and 10.0 g magnetite particles (D₅₀ 100 μm) in a plastic flask for 30 minutes. The 1,2,3-trilauroyl glycerol then adheres to the surface of the magnetite particles. Subsequently, 60.0 g poly-(methylmethacrylate-co-methylacrylate) and 2.0 g dibenzoylperoxide (desensitized with 25% water) were added. The mixture was further triturated for another 30 minutes. After the trituration, the cement powder was present as a gray-brown powder.

### Example 2

A total of 40.0 g of the cement powder produced in Example 1 were mixed with 20 ml of a mixture of 18.40 g methylmethacrylate and 0.38 g p-N,N-dimethyl-toluidine. A homogeneous cement dough was thus produced within 30 seconds and cured after a few minutes. The cement dough was used in a plastic mold to produce a cylindrical form body (height 10 mm, diameter 25 mm), whereby an electronic temperature probe was positioned in the middle of the form body. The cured form body was heated over the course of two minutes using an induction heating (coil with control electronics, frequency 25 kHz) of the type that is common in conventional conduction cookers. The maximal temperature measured on the inside of the form body was 43-44° C.

1. A polymethylmethacrylate bone cement composition for controlled hyperthermia treatment comprising,
A polymethylmethacrylate;
B radio-opaquer;
C methylmethacrylate and/or alkylmethacrylates;
D initiator system;
E ferromagnetic and/or superparamagnetic particles having a particle size of up to 500 μm; and
F at least one biodegradable or biocompatible crystalline substance having a melting point in the range of 42-80° C.

2. The polymethylmethacrylate bone cement composition according to claim 1, wherein the ferromagnetic and/or superparamagnetic particles are partially or completely enveloped by the crystalline substance.

3. The polymethylmethacrylate bone cement composition according to claim 1, wherein the ferromagnetic and/or superparamagnetic particles comprise iron, cobalt, samarium-cobalt, neodymium-iron (Nd₂Fe₁₄) or magnetite.

4. The polymethylmethacrylate bone cement composition according to claim 1, wherein the crystalline substance is selected from the group consisting of 1,2,3-trilauroyl glycerol, 1,2,3-trimyristyl glycerol, 1,2,3-tripalmitoyl glycerol, lauric acid, myristic acid, and palmitic acid.

5. The polymethylmethacrylate bone cement composition according to claim 1, wherein the fraction of crystalline substance present in the polymethylmethacrylate bone cement is up to 30 weight percent relative to the total mass.

6. The polymethylmethacrylate bone cement composition according to claim 1, further comprising at least one cytostatic agent.

7. (canceled)

8. (canceled)

9. (canceled)
